(19) United States
(12) Patent Application Publication
(10) Pub. No.: US 2002/0056171 A1
(43) Pub. Date: May 16, 2002

(54) Door handle arrangement for a door of a vehicle and method of making

(76) Inventors: Rudi Koelle, Sindelfingen (DE); Martin Lindmayer, Sulz a. N. (DE)

Correspondence Address: CROWELL & MORING LLP, INTELLECTUAL PROPERTY GROUP, P.O. BOX 14300, WASHINGTON, DC, 20044-4300, US

(21) Appl. No.: 09/986,995

(22) Filed: Nov. 13, 2001

(30) Foreign Application Priority Data
Nov. 11, 2000 (DE) 100 56 042.3

(51) Int. Cl. E05B 1/00

(52) U.S. Cl. 16/110.1

(57) ABSTRACT

A door handle arrangement for a door of a vehicle, especially an automobile, having an outer handle pull for opening a door lock and a door, which is mounted at its forward or rear end, relative to the longitudinal axis of the vehicle, to a support component within a mounting, such that the handle pull can pivot around a swiveling axis, and such that it pivots toward the outside when the door lock is opened. In order to reduce wear and tear on the door handle arrangement when the door lock is opened, while increasing comfort for the user, the mounting is designed such that the swiveling axis is tilted relative to a vertical axis, so that the handle pull pivots upward and toward the outside when the door lock is opened.

### BACKGROUND AND SUMMARY OF THE INVENTION

This application claims the priority of German Patent Document DE 100 56 042.3, filed on Nov. 11, 2000, the disclosure of which is expressly incorporated by reference herein.

The invention relates to a door handle arrangement for a door of a vehicle, especially an automobile, possessing an outside handle pull for opening a door lock and the door, said outside handle pull being mounted at a forward or rear end, relative to a longitudinal axis of the vehicle, to a carrier component within a mounting, such that the handle pull pivots toward an outside when the door lock is opened.

A door handle arrangement of this type is known, for example, from German Patent Document DE 30 30 519 C2, and possesses an outer handle pull, which is used both to open the door lock and to open the door. This handle pull is mounted, at its forward end relative to the longitudinal axis of the vehicle, on a support component within a mounting, such that it can pivot around a swiveling axis. When the door lock is opened, in other words when the handle pull is manually actuated, the door handle pivots outward. With this known door handle arrangement, the mounting for the handle pull is designed such that the swiveling axis for the handle pull is vertical. Accordingly, the swiveling axis of the handle pull extends parallel to the swiveling axis of the vehicle door, to which the door handle arrangement is mounted. A person wishing to open the door lock and the door can thus pull the handle pull in the same direction to open the door lock and to open the door, wherein the motion required to open the door lock changes into the motion required to open the door. This type of kinematics are considered especially comfortable, and are thus of considerable importance in terms of the functional value of the door handle arrangement.

In order for the lowest possible level of manual actuating force to be applied to the handle pull to open the door lock, the actuating force must be applied perpendicular to the swiveling axis, which in this case is horizontally in the handle pull. The user must thus pull the handle pull horizontally, toward himself, in order to realize minimal actuating force. Especially in the case of automobiles, the handle pull is positioned so low on the door for the average user, that the user will also intuitively pull the handle upward, to a greater or lesser degree, when opening the door. This introduces force components into the handle pull that extend parallel to the swiveling axis. These upward force components must be supported by the mounting and by a guide mechanism for the handle pull that may be included in the arrangement, which increases the actuating force required to open the door lock. Furthermore, the force components that extend cross-wise to the swiveling movement of the handle pull serve to increase friction in the mounting and in a guide mechanism for the handle pull that may be included in the arrangement. This further effects an increase in the actuating force required to open the door lock.

If the handle pull is guided via a guide mechanism in the support component, the upward force component—depending upon the quality of this guide mechanism—may cause the handle pull to tilt within the guide mechanism, causing the handle to become stiff and may cause it to become jammed. Because the average user also intuitively pulls upward when opening the door lock, he must apply greater actuating force to the handle pull than is actually necessary to open the door lock. To achieve a high level of comfort, however, the lowest level of actuating force is desirable. Furthermore, with this type of actuation, relatively high levels of strain are placed upon the door handle arrangement, so that, in order for it to have a long working life, the door handle arrangement is relatively costly, and thus expensive to produce.

In German Patent Document DE 197 24 572 C1, a door handle arrangement that is different in principle is known, in which an outside handle pull is mounted on a support component, along a side of the component that faces the door, such that the handle pull can pivot around a swiveling axis. Further, this swiveling axis extends along the longitudinal axis of the vehicle. In addition, the swiveling axis is tilted relative to a horizontal axis, such that the handle pull swivels upward and forward when the door lock is opened. A door handle arrangement of this type differs fundamentally from customary door handle arrangements in that the handle pull goes through a very different series of movements in the opening of the door lock and the subsequent opening of the door. These movements do not merge one into the other as with the more common door handle arrangement, so that the desired level of comfort is missing.

An aspect of the present invention is to provide an embodiment for a door handle arrangement of the type described at the beginning, in which the actuating force required to open the door lock is reduced, thus ensuring the desired level of comfort.

This aspect is attained in accordance with certain preferred embodiments of the invention via a door handle arrangement providing that the mounting is designed such that the swiveling axis is tilted relative to a vertical axis, such that the handle pull pivots upward and toward the outside when the door lock is opened.

Certain preferred embodiments of the invention are based upon the general concept of tilting the swiveling axis of the handle pull far enough relative to a vertical axis that the direction of the minimum actuating forces, which extends crosswise to the swiveling axis, possesses a component that is oriented upwards, in addition to the component that is oriented toward the outside. This measure makes it possible to orient the direction of the minimum actuating force required via a corresponding tilting of the swiveling axis, such that it extends parallel to a preferred direction of pull, in other words parallel to the direction in which the average user will most likely pull. For example, the swiveling axis may be tilted at an angle of approximately 15° relative to a vertical axis. With the design for the door handle arrangement specified in certain preferred embodiments of the invention, the forces of support and friction in the mounting are reduced. The actuating force that must be applied by the user is also reduced accordingly, along with wear and tear on the door handle arrangement.

In accordance with a further aspect, the handle pull may be held within a guide mechanism, at the end of the pull that faces away from the mounting, with the sides of the guide mechanism defining the direction of the guide mechanism, which is tilted relative to a horizontal axis, such that the angle between the direction of the guide mechanism and the horizontal axis is the same size as the angle between the swiveling axis and the vertical axis. The guide mechanism may also be oriented along the preferred direction of pull, so that forces of support and friction in this guide mechanism, along with wear and tear, are also reduced.

It is advantageous to provide a guide element for the handle pull that is held within this guide mechanism and is equipped with contact zones, which extend parallel to the sides of the guide mechanism. This serves to reduce the danger of an undesired tilting, especially a jamming.

In accordance with a certain embodiment, the handle pull may be provided with a manually actuated grip area between its two ends, the visible sides of which may have any type of design. Preferred, however, are embodiments in which the outer side that faces away from the door extends nearly perpendicular. In addition, or as an alternative to this, an upper side and/or a underneath side of the handle pull, at least in the area of its ends, may extend nearly horizontally. Thus, the visible form of the handle pull, that is, primarily the grip area, may be designed such that the handle pull of the door handle arrangement specified in certain preferred embodiments of the invention cannot be differentiated from the customary door handle arrangement. Only when it is actuated, in other words when the user pulls on the handle pull, is the difference apparent, as the door lock can be opened much more easily. For this reason, with the door handle arrangement specified in certain preferred embodiments of the invention, the visible area may be design-dependent, to correspond with the desired visual effect.

Further significant characteristics and advantages of the invention are found in other embodiments, in the diagrams, and in the description of the illustrations in the diagrams.

It is understood that the above-mentioned characteristics and those to be described in greater detail below are applicable not only in the combination indicated here, but also in other combinations, or alone, without deviating from the framework of the present invention.

One preferred exemplary embodiment of the invention is illustrated in the diagrams, and will be specified in greater detail in the following description.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a partial cross-section along the longitudinal axis of the vehicle of a first side of the door handle arrangement as specified in certain preferred embodiments of the invention,

FIG. 2 shows a view as in FIG. 1, but of a second side of the door handle arrangement in a first position, and

FIG. 3 shows a view as in FIG. 2, but in a second position.

### DETAILED DESCRIPTION OF THE DRAWINGS

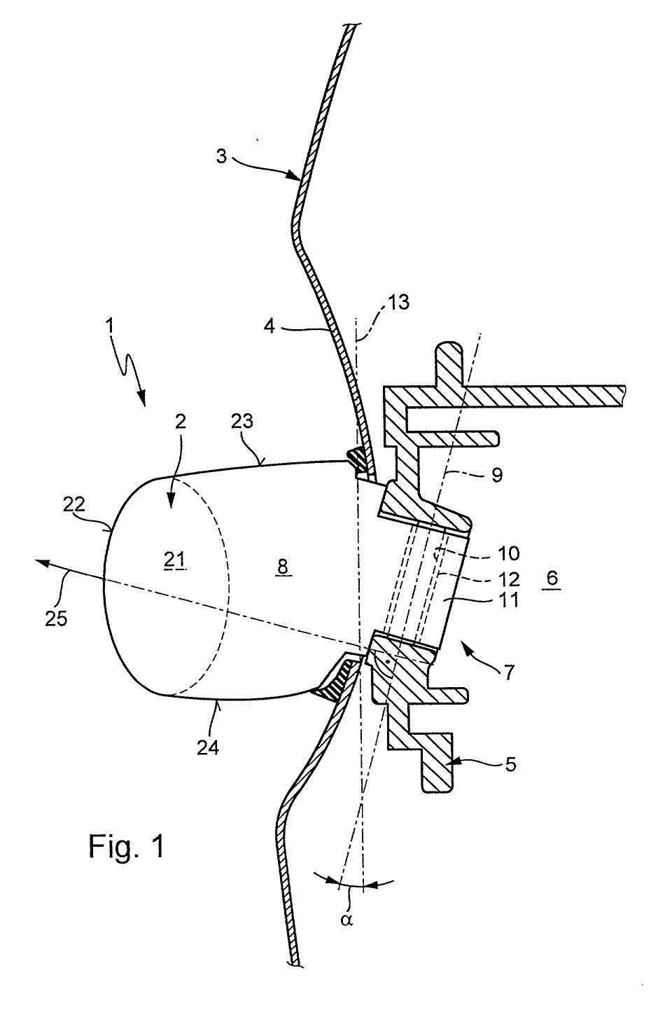

In FIGS. 1-3, a door handle arrangement 1 is equipped with a handle pull 2, which is positioned outside, on the door of a vehicle 3, for example within a handle recess 4. Here, only a small section of the door of the vehicle 3 is shown, which is preferably the door 3 of an automobile. The handle pull 2 is mounted through the outer shell of the door 3 on a support component 5 of the door handle arrangement 1, which is positioned on the inside 6 of the door 3. To this end, a mounting 7 is provided, on the side of the door handle arrangement 1 that faces the viewer in FIG. 1, via which the handle pull 2 is mounted, at its end 8 that in FIG. 1 faces the viewer, on the support component 5, such that the handle pull can pivot around a swiveling axis 9. For example, this mounting 7 may comprise a spindle 10 designed as part of the carrier component 5, which extends through a mount opening 12 designed as part of the handle pull 2, or as part of a corresponding extension 11 of the handle pull 2. Of particular importance in this is that the swiveling axis 9 is tilted inward relative to a vertical axis 13, forming an angle α with this vertical axis, which may measure 15°, for example. The angle α can, in principle, have any value that is greater than 0° and less than 90°. However, values between 5° and 45° are preferred.

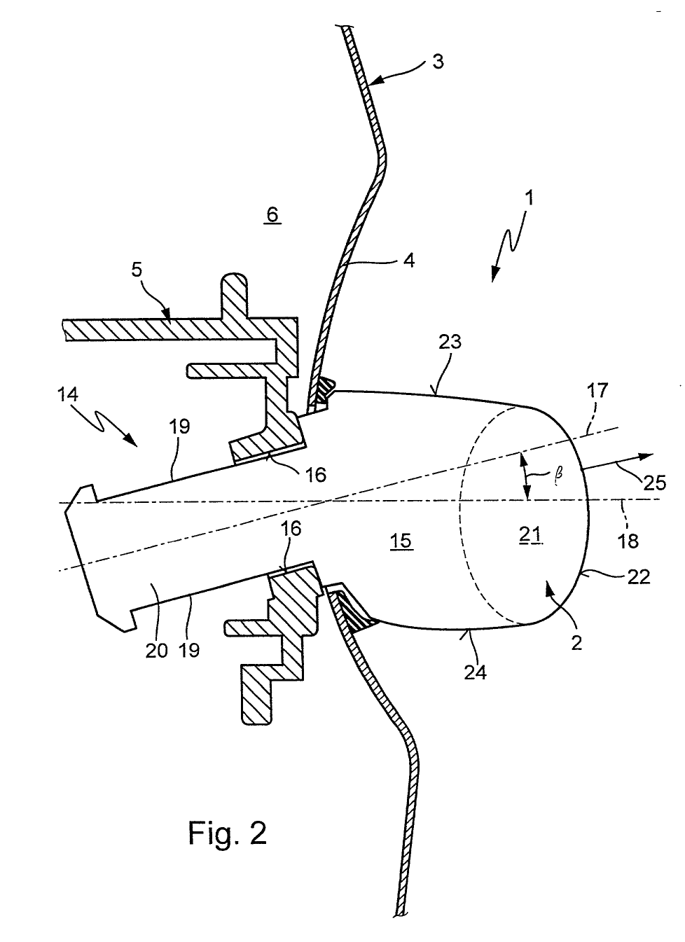

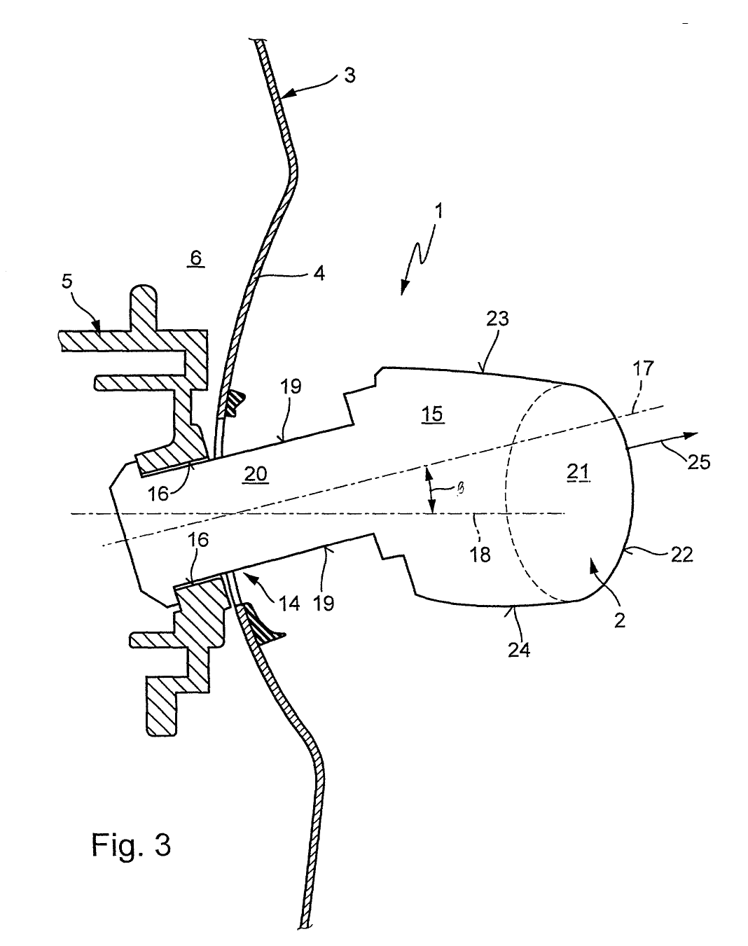

On a side of the door handle arrangement 1 that in FIGS. 2 and 3 is turned toward the viewer, a guide mechanism 14 is provided, with which the handle pull 2 is guided laterally on the support component 5, in this case at least above and below, at its end 15 that in FIGS. 2 and 3 is turned toward the viewer. To this end, the guide mechanism 14 is equipped with upper and lower sides 16, which are designed to be linear or flat, and extend parallel to a direction 17 for the guide mechanism that is defined by the sides 16, and is tilted upward relative to a horizontal axis 18, thereby forming the angle β which measures 15°, for example. Correspondingly, the guide direction 17 lies within a plane that extends perpendicular to the swiveling axis 9. In the guide mechanism 14, the guide sides 16 operate in conjunction with contact zones 19, which are provided on the handle pull 2 or on an extension 20 of the handle pull 2 which serves as the guide element. The guide sides 16 lie adjacent to the contact zones 19 to provide a guiding surface. Preferably, the contact zones 19 are also designed to be linear or flat, and extend parallel to the guide direction 17, in other words parallel to the sides of the guide mechanism 14.

The handle pull 2 extends approximately parallel to a longitudinal axis of the vehicle, which in FIGS. 1-3 extends perpendicular to the plane of the diagram. Preferably, the door handle arrangement 1 is mounted such that the end 8 that operates in conjunction with the mounting 7 is positioned toward the front, relative to the direction of travel of the vehicle, while the end 15 that operates in conjunction with the guide mechanism 14 is positioned toward the rear relative to the direction of travel. Both the forward end 8 and the rear end 15 will be discussed below. Between its forward end 8 and its rear end 15, the handle pull 2 is equipped with a hand grip 21 which is manually actuated.

The door handle arrangement 1, as specified, functions as follows:

When a user wishes to open the vehicle door 3 or a door lock that is coupled to the door handle arrangement 1 but is not illustrated here, he grasps the hand grip 21 and pulls on it. With the average user, this creates a resulting actuating force 25, which is indicated in the diagrams by an arrow. This actuating force 25 possesses a preferred actuating or pull direction, which extends approximately parallel to the guide direction 17. This actuating force thus possesses components that are oriented toward the outside, parallel to the horizontal axis 18, and components that are oriented parallel to the vertical axis 13, thus upwards.

The tilt of the swiveling axis 9 of the mounting 7, as specified, and the tilt of the guide direction 17 of the guide mechanism 14, as specified, are determined, for example, via statistical and/or ergonomic tests. Since, in accordance with certain preferred embodiments of the invention, the statistically and/or ergonomically preferred direction of actuation coincides with the guide direction 17, a relatively low level of actuating force 25 is necessary to pivot the handle pull 2 around its swiveling axis 9. Thus, as illustrated in FIGS. 2 and 3, its rear end 15 is moved toward the outside and upwards. While FIG. 2 shows an idle position for the handle pull 2, FIG. 3 shows the position of maximum extension for the handle pull 2. When the handle pull 2 is pulled outward, this actuates the door lock via known means, allowing the door 3 to be opened. To actuate the door lock, the handle pull 2 is coupled with the door lock via known means, thus, for example, the extension 20 operates either directly or indirectly with the door lock via a lever.

The optimal direction of actuation for the handle pull 2 is defined by the guide direction 17 and the swiveling axis 9. Since the guide direction 17 is chosen, in accordance with certain preferred embodiments of the invention, to correspond to the ergonomic direction of force that is intuitively applied by the average user, the door 3 or the door lock can be opened especially easily and comfortably. This is because, in the optimal direction of actuation, additional forces of support and friction in the mounting 7 and in the guide mechanism 14 are low, and a tilting or jamming in the guide mechanism can be prevented. At the same time, the door handle arrangement 1 is subjected to a reduced level of stress, so that it can be produced more cost-effectively, with the same working life.

It is further noteworthy, that the visible area of the handle pull 2, primarily the hand grip 21 and the ends 8 and 15, can be designed in terms of their aesthetics entirely independently from the mounting 7 and guide mechanism 14, which are positioned on the inside 6 of the door 3. For example, an outer surface 22 of the hand grip 21, which faces away from the door 3, may be oriented largely perpendicular. Furthermore, an upper side 23 and an underneath side 24 of the ends 8 and 15 may be oriented largely horizontally, so that the handle pull 2 may appear basically identical from the outside to handle pulls used in traditional door handle arrangements, in which the swiveling axis is basically perpendicular.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A door handle arrangement for a door of a vehicle, comprising an outside handle pull for opening a door lock and the door, said outside handle being mounted at a forward or rear end, relative to a longitudinal axis of the vehicle, to a carrier component within a mounting, such that said handle pull can pivot around a swiveling axis, and such that the handle pull pivots toward an outside when the door lock is opened,
wherein the mounting is designed such that the swiveling axis is tilted relative to a vertical axis, such that the handle pull pivots upward and toward the outside when the door lock is opened.

2. A door handle arrangement according to claim 1,
wherein the handle pull is guided within a guide mechanism, at an end that faces away from the mounting, with sides of the guide mechanism defining a guide direction that is tilted relative to a horizontal axis, and
wherein an angle between the guide direction and the horizontal axis is substantially equal to an angle formed between the swiveling axis and the vertical axis.

3. A door handle arrangement according to claim 2, wherein a guide element held within the guide mechanism of the handle pull is equipped with contact zones, which extend substantially parallel to the corresponding sides of the guide mechanism.

4. A door handle arrangement according to claim 1,
wherein the handle pull is equipped with a manually actuated hand grip between the two ends, and
wherein an outer side of the hand grip, which faces away from the door, extends approximately perpendicular to the door, at least in areas.

5. A door handle arrangement according to claim 2,
wherein the handle pull is equipped with a manually actuated hand grip between the two ends, and
wherein an outer side of the hand grip, which faces away from the door, extends approximately perpendicular to the door, at least in areas.

6. A door handle arrangement according to claim 3,
wherein the handle pull is equipped with a manually actuated hand grip between the two ends, and
wherein an outer side of the hand grip, which faces away from the door, extends approximately perpendicular to the door, at least in areas.

7. A door handle arrangement according to claim 1, wherein at least in an area of the ends, an upper side or an underneath side of the handle pull extends approximately horizontally.

8. A door handle arrangement according to claim 2, wherein at least in an area of the ends, an upper side or an underneath side of the handle pull extends approximately horizontally.

9. A door handle arrangement according to claim 3, wherein at least in an area of the ends, an upper side or an underneath side of the handle pull extends approximately horizontally.

10. A door handle arrangement according to claim 4, wherein at least in an area of the ends, an upper side or an underneath side of the handle pull extends approximately horizontally.

11. A door handle assembly for a vehicle door, comprising:
an exterior handle pull for opening a door lock and the door,
a support component having a mounting, the handle pull being mounted at a first longitudinal end within the mounting thereby the handle pull pivots about a swiveling axis to open the door lock,
wherein the mounting is inclined upwards toward an exterior of the vehicle so that the swiveling axis is tilted relative to a vertical axis and the handle pull pivots upward and outward when the door lock is opened.

12. A door handle assembly according to claim 11, wherein the handle pull is guided within a guide at a second longitudinal end, a side of the guide defining a guide direction which is substantially perpendicular to the swiveling axis.

13. A method of making a door handle arrangement for a vehicle door, having an outside handle pull for operatively opening a door lock and the door, comprising:
providing a carrier component with a mounting in the vehicle door,
arranging the mounting to incline upwards towards an exterior of the door, and
mounting the outside handle pull at a longitudinal end within the mounting so that the handle pull pivots outwardly about a swiveling axis and the swiveling axis is tilted relative to a vertical axis.

14. A method according to claim 13,
wherein the handle pull is guided within a guide mechanism, at an end that faces away from the mounting, with sides of the guide mechanism defining a guide direction that is tilted relative to a horizontal axis, and
wherein an angle between the guide direction and the horizontal axis is substantially equal to an angle formed between the swiveling axis and the vertical axis.
